(19) United States
(12) Patent Application Publication
(10) Pub. No.: US 2007/0223165 A1
(43) Pub. Date: Sep. 27, 2007

(54) Line powering in a multi-line environment

(76) Inventors: Benedict A. Itri, Newport Beach, CA (US); Christopher S. Smith, Mission Viejo, CA (US)

Correspondence Address: WEIDE & MILLER, LTD., 7251 W. LAKE MEAD BLVD., SUITE 530, LAS VEGAS, NV, 89128, US

(21) Appl. No.: 11/386,509

(22) Filed: Mar. 22, 2006

(51) Int. Cl. H01H 73/00

(52) U.S. Cl. 361/115

(57) ABSTRACT

A line powering system for a multi-channel communication system is disclosed having a central office or primary communication terminal configured to communicate with one or more remote locations via two or more communication lines. Line powering, from the primary location to the remote location, is provided by a power supply, which is selectively connected to one or more of the lines via a switching module. Line monitoring and switch control may occur automatically or by a controller. A ground fault detector is provided to monitor for excessive ground fault current and selectively disconnect the faulted line. A rapid line voltage discharge module is provided to discharge line voltage to meet specification.

### FIELD OF THE INVENTION

The invention relates to line powering remote communication devices and in particular to a method and apparatus for line powering remote terminals in a multi-line point to point communication system or multi-line point to multi-point communication system.

### RELATED ART

Many communication systems have been developed and implemented to exchange data between remote locations. The locations, at which the communication devices are placed, are often connected by a communication channel capable of conveying the data between each location. The locations may comprise any type locations such as a central office, office building equipment room, repeater stations, cellular telephone base station, or individual office.

As can be appreciated, the communication devices require power, in the form of electricity, to achieve operation of the communication systems. Hence, power must be provided to the communication device locations. In the example environment of a central office communicating with a remote terminal, power is often readily available at the central office. The remote terminal, however, may not be near a power source, or the available power source may already be supplying power at capacity to other devices. Pulling addition cabling and connecting power, if possible, may be difficult and expensive.

Likewise, power is an expensive resource which is usually metered to a particular user. In a shared equipment room containing a remote terminal, shared power usage may create metering complexities or providing power may unfairly burden certain parties.

In addition, disruptions to the power supplied to a remote location will likewise disrupt exchange of data between the two communication systems if the remote communication device is dependant on power at the remote location. In the example environment of a central office and remote terminal, disruption of power to either the central office or the remote terminal will prevent the exchange of data. Often the communication link carries important business, safety, or personal data and disruption of the communication link is highly undesirable. While the central office may be battery backed, the remote terminal may not have such a luxury and hence, a disruption of power at the remote location, where the remote terminal is located, would disrupt data exchange.

To overcome these drawbacks, line power has been proposed. Line power is traditionally understood as the providing of power for operation of a communication device via the communication channel. The most common form of line powering was utilized in the U.S. telephone system wherein the telephone received power via the twisted pair copper telephone line. As a result, the telephone did not plug into an AC power outlet.

Demands for higher communication rates and more efficient usage of existing communication paths have lead to development of multi-line communication systems. In a multi-line communication system implemented in a central office environment, multiple conductors may be utilized to connect a central office (CO) communication device to a remote terminal. These systems often demand more power for operation and as such, the burdens and drawbacks discussed above are particularly relevant.

Prior art systems that utilize line powering suffer from numerous drawbacks. One such drawback is that prior art systems, when configured as multi-line communication systems, simply duplicate a single line powering circuit for each line. For example, in a communication system receiving power from five lines, prior art multi-line systems simply duplicate a prior art single line, line powering circuit five times. This may involve use of 5 power supplies, five safety isolation systems, and the like. This is undesirably expensive as the same line powering hardware and functionality is repeated for each line thereby leading to a duplication of equipment and increased power consumption.

Another drawback arises due to the inflexibility of prior art systems when dealing with difficulty on a particular line. For example, in a prior art system having five powered lines, when any one of those five lines does not supply sufficient power, the entire remote terminal will likewise become inoperable because insufficient power is flowing to the remote device. As can be appreciated, this scenario is undesirable because system operation is dependent on all five lines supplying adequate power.

The method and apparatus disclosed herein overcomes the drawbacks of the prior art and provides additional benefits and advantages as discussed herein.

### SUMMARY

Disclosed herein is a method for line powering a multi-line remote communication terminal from a primary communication device which overcomes the drawbacks of the prior art and provides additional benefits. In one method of operation, the line powering operation receives power at a primary communication device from a power source and then selectively sets one or more switches to energize one or more lines with power. According, the remote communication terminal is powered via the one or more energized lines. The application of power on the energized lines does not preclude those lines from carrying useful data traffic. At the discretion of the primary communication device, each line may be independently activated to carry power, information data, or both at the same time.

At the primary communication device, the operation monitors the one or more energized lines for a fault or failure. Responsive to detecting a fault or failure the primary communication device disconnects the energized line on which the fault or failure was detected. In addition, the primary communication device may detect a degradation that is not at a level of severity as a fault or failure. In that case, the device may alert the user or management entity to a potential future failure, but not take autonomous action.

In one embodiment the fault or failure comprises a high current event, a low current event, a high voltage event, a low voltage event, or a leakage of current to protective ground, commonly known as ground fault. In addition, this method may further comprise the step of, responsive to detecting a fault or failure, establishing and monitoring a timer. The primary device may then re-connect the disconnected line to thereby re-energize the line based on the timer output. The method may also further comprise monitoring the one or more energized lines for a fault or failure after re-connection and, responsive to detecting a fault or failure, disconnecting the re-connected line on which the fault or failure was detected to thereby de-energize the re-connected line.

It is also contemplated that this method of operation may further comprise detecting, at the remote communication terminal, the disconnecting of the energized line at the primary communication device and, responsive to the detecting at the remote communication terminal, disconnecting a power supply at the remote communication terminal from the de-energized line. Thus, the disconnecting of the line is automatically detected at the remote terminal.

Also disclosed herein is a method, for use within a multi-line communication system, for locating a communication channel on which a ground fault is occurring and disconnecting the line from a line powering circuit. One embodiment of this method comprises providing power to the line powering circuit within a multi-line communication system and connecting the powered lines to a line powering circuit to provide power to a remote terminal. This method then monitors ground current sourced to ground from all of the powered lines and compares the ground current to a threshold. Responsive to a ground current that is greater than the threshold, disconnecting one or more powered lines from the line powering circuit in a certain sequence or any sequence, and re-comparing the ground current to the threshold until the ground current is less than the threshold. Then, upon determining if the ground current is less than the threshold, stopping the sequential disconnecting and leaving the presently disconnected line disconnected, either permanently or temporarily.

In one embodiment, the multi-line communication system may comprise a point to point communication system or point to multi-point communication system. Furthermore, the method may utilize a single shared ground current detector. In one configuration, the act of disconnecting comprises utilizing a switch within an integrated circuit element to disconnect each line from the line powering circuit. This may occur automatically with input from a controller or processor. The method may further comprise detecting the disconnected line at the remote terminal and responsive to the disconnecting, disconnect the line at the remote terminal from a remote terminal power supply.

In addition to these methods, also disclosed herein is a system for line powering a multi-line remote communication terminal via one or more communication lines. This system comprises a power supply configured to provide power to one or more communication lines and an actuation unit configured to selectively connect power to one or more of the communication lines to create one or more powered lines. Also part of this system is a sensing unit configured to monitor one or more aspects of one or more powered lines to create line status information. A controller is provided and is configured to receive line status information from the sensing unit and process the line status information to determine if a fault or failure is present on a line. Responsive to a fault or failure, the controller controls the actuation unit to disconnected power from a line on which a fault or failure was detected.

In one embodiment this system further comprises a discharge module that connects to one or more of the powered lines. The discharge module is configured to discharge power on the line responsive to the line being disconnected from power. This system may further comprise a remote communication terminal configured to receive power via one or more communication lines and supply the received power from a remote communication terminal power supply to the remote communication terminal. It is contemplated that the terminal may comprise one or more coupling networks configured to detect removal of power from a line and responsive to such detection, disconnect the line from the power supply in the remote communication terminal.

The controller of this system may comprise a processor and machine readable code such that the machine readable code executes on the processor. In one embodiment the line status information comprises a voltage value or a current value and the controller converts this voltage value or current value to a digital value. The controller then performs a comparison of the digital value to a threshold, and responsive to the comparison, removes power from the line associated with the line status information. Also potentially part of this system is a timer configured to generate a signal, after a predetermined amount of time, which reconnects the disconnected line to power. If a ground fault detector is included, then it may be configured to detect a ground fault and, responsive to the detection, provide a signal to the controller.

In another embodiment a line powering system for a multi-line communication device having a central office terminal and one or more remote terminals is provided wherein the one or more remote terminals receive data and power from the central office terminal. This system may be configured with a power source at the central office terminal configured to supply power to one or more lines which may be selectively connected to the power source. A controller is provided and configured to monitor the one or more lines connected to the power source and generate one or more switch control signals. The switch control signals are provided to one or more switches configured to selectively connect or disconnect, responsive to the one or more switch control signals, one or more lines to the power source.

In one embodiment this system further comprises an interface configured to provide access to the controller from a host. In addition, a single controller and power source may be shared by all of the lines while a switch may be associated with each line. A discharge module, configured to quickly discharge power on the line, may connect to a line to discharge line power by shunting line power. This system may also further comprise a ground fault detector configured to detect a ground fault on a line and provide a ground fault detected signal to one or more switches, the controller, or both.

As discussed below in more detail, the system may further comprise remote terminal line powering components comprising a power supply configured to receive and combine power from two or more lines and provide power to the remote terminal. In addition, a sensing and switching module may be configured to detect when power is not present on a line and, responsive to a line not being powered, disconnect the line from the power supply. It is contemplated that the sensing and switching module may be further configured to connect a line to the power supply when the line is connected to the power at the central office terminal.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A illustrates an example embodiment of a multi-line point to point communication system.

FIG. 1B illustrates a detailed block diagram of an example embodiment of a line powered, multi-line point to point communication system.

FIG. 2A illustrates an example embodiment of a point to multi-point communication system.

FIG. 2B illustrates a detailed block diagram of an example embodiment of a line powered, multi-line point to multi-point communication system.

FIG. 3 illustrates a block diagram of an example embodiment of a multi-line communication system with line powering for the remote terminal.

FIG. 4A illustrates a block diagram of an example embodiment of the individual power control and current sensing and line coupling network.

FIG. 4B illustrates a diagram of an example implementation of the coupling network.

FIG. 5A illustrates a block diagram of an example embodiment of remote terminal coupling network.

FIG. 5B illustrates an example implementation of the example embodiment of FIG. 5A.

FIG. 6 illustrates an example embodiment of a ground fault sensor.

FIG. 7 illustrates an operational flow diagram of an example method of operation, such as for example, a typical algorithm for monitoring the line currents and line voltage.

FIG. 8 illustrates an operational flow diagram of a typical algorithm for monitoring ground fault conditions.

### DETAILED DESCRIPTION

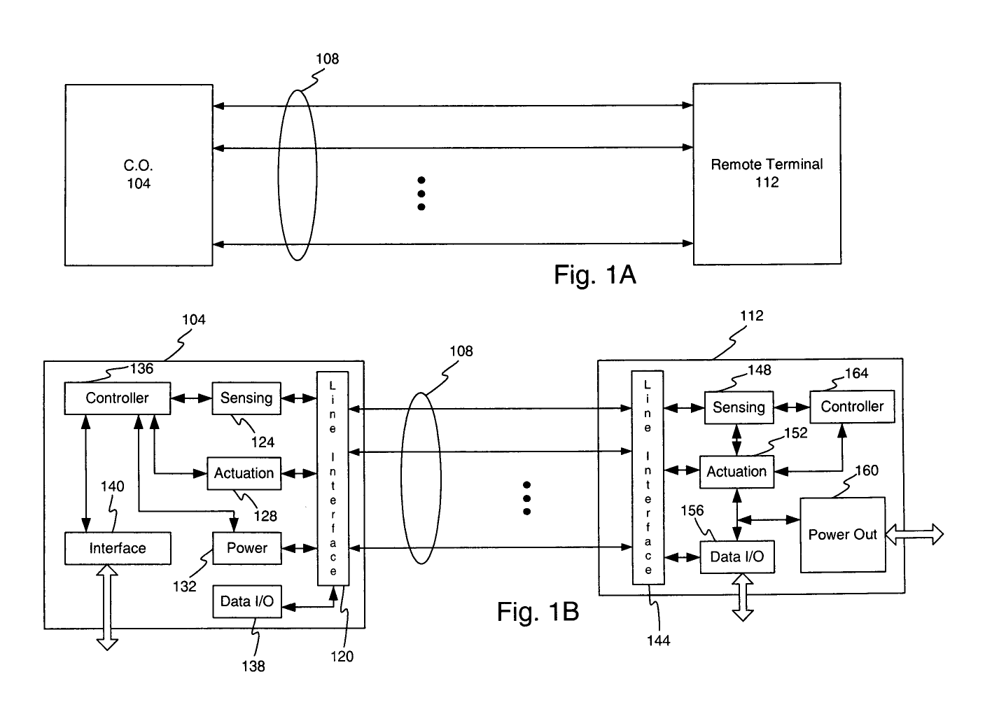

FIG. 1A illustrates an example embodiment of a multi-line point to point communication system. As shown, a central office (CO) device 104 communicates via two or more lines 108 with a remote terminal 112. As used herein, the channel collectively comprises two or more lines. The two or more lines 108 may comprise any type of communication path. The CO device 104 and remote terminal 112 utilized the two or more lines 108 to improve data transfer efficiency. In this embodiment, it is contemplated that the CO device 104 may supply power to the remote terminal 112 via the two or more lines 108 to thereby form a line powered communication system.

FIG. 1B illustrates a block diagram of an example embodiment of a line powered, multi-line point to point communication system. In this example embodiment, a CO device 104 connects to the lines 108 via a line interface 120. Within the CO device 104, the line interface 120 may comprise one or more switches, not shown. In turn, the line interface 120 connects to a sensing unit 124, an actuation unit 128 and a power supply unit 132. The sensing unit 124, the actuation unit 128 and power supply unit 132 connect to a controller 136 as shown. The controller 136 may be accessed via an interface 140, which may be used by a user or other system to communicate with the CO device 104. A data input/output 138 is provided for data input and output from the CO device 104, for data to be transported over the lines 108 to the remote terminal 112. The CO communication device, which may located at any location instead of a central office, may also be referred to as a primary communication device.

The line interface 120 connects to the two or more lines 108 and provides for transmission and receipt of data via the channels. This embodiment comprises a line powered system where in the remote terminal 112 receives power via the channel 108. In this embodiment, the power supply unit 132 provides power to the line interface 120, which in turn and subject to control input from the sensing unit 124 and the actuation unit 128, selectively provides power to the lines.

The sensing unit 124 monitors one or more aspects of the lines that may concern power delivery via the two or more lines. The sensing unit 124 may communicate the results of the sensing to the controller 136 as shown, or directly to an actuation unit 128. It is contemplated that the sensing unit 124 may monitor an individual line or the entire channel concurrently or in a specific sequence. As a result of the monitoring of the two or more lines by the sensing unit 124, the sensing unit may detect when one of the lines is unsuitable to be used for line powering of the remote terminal 112. It is contemplated that the aspects of the line which may be sensed or monitored include, but are not limited to tip-and-ring (the two conducting wires in each line) short circuits, tip or ring open circuits, and tip ground fault or ring ground fault. The term fault or failure is defined to mean voltage or current values across a line that are outside the normal range for system operation. For example, an open circuit will result in zero current or less than a threshold amount of current delivered through the line negating its ability to power the remote device. A short circuit or a ground fault will result in exceedingly high and unsafe current levels passing through the line, endangering the integrity of the devices and the safety of technical personnel.

The actuation unit 128, responsive to input from the controller 136, sensing unit 124, or both, may un-power one or more of the lines 108 by disconnecting the line from the power supply 132. It is contemplated that the actuation unit 128 may also connect one or more lines 108 to the power supply 132 to thereby force a particular line to carry power to the remote terminal 112.

The controller 136 may oversee or guide operation of the sensing unit 124, line interface, and the actuation unit 128. By way of example and not limitation, the controller 136 and/or sensing unit 124 may detect an unwanted line powering event on one of the lines 108. The unwanted event may comprise any event described herein. All lines may be monitored concurrently or each line may be analyzed in a specific sequence. Upon detection of such an event the controller 136 or sensing unit 124 may disconnect the line 108, such as with the aid of the actuation unit 128, from the power supply 132 thereby removing the particular line from the line power circuit.

It is contemplated that after a time out period, the particular line 108 may be re-connected by the actuation unit 128 and thereafter the sensing unit 124 may continue to monitor the line to determine if the unwanted event is no longer affecting the line. If not, then the actuation unit 128 may maintain the line 108 in the line power circuit. If the unwanted event remains, then the actuation unit 128 may again remove the particular line 108 from the line powering circuit. This process may repeat or terminate after a fixed number of iterations. During this time, it is contemplated that one or more of the other lines are executing the line power function and are likewise being monitored and optionally switched into or out of the line powering circuit.

A user interface 140 is provided for a user or other system to communicate with, exchange data with, interrogate, or control one or more settings of the controller 136. The output of the controller 136 to the interface may comprise status or monitoring information regarding the health of each line, for example line current information, or other line information. It may also comprise alarms or reporting of line powering events.

One function of the interface 140 is to provide data connectivity to the controller 136, while at the same time maintaining electrical isolation of the controller 136 as well as the power subsystem 104 from the rest of the primary communication device. This is desirable because the power subsystem 104 may be subjected to high voltages (due to line powering events), which would be harmful if propagated to the sensitive electronics of the rest of the system. In other embodiments the controller 136 may not be isolated

At the remote terminal 112 a similar configuration may be present to insure that synchronized operation occurs and maintain desired safety and isolation requirements. In this example embodiment, a line interface 144 connects to the two or more lines 108 to interface the channel with the other apparatus of the remote terminal 112. The line interface 144 may comprise one or more switches. Alternatively, one or more switches may be located within an actuation unit 152.

A sensing unit 148 connects to the line interface 144 and is configured to monitor for line power on a particular line. If the sensing unit 148 detects power on the line, then the line 108 may remain connected to the line power circuitry. In this example embodiment, if a line 108 remains powered by the CO device 104, then it is assumed that the line is functioning properly because the CO sensing unit 124 has not detected an unwanted event.

Alternatively, if the CO has disconnected a particular line from the CO line powering circuitry, then the particular line will not be powered. The sensing unit 148 will detect the lack or removal of power on the particular line by the CO 104 and, in response, the sensing unit 148 will signal the actuation unit 152 to disconnect the line powering aspects of the particular line from the line powering circuitry. This prevents the unwanted event from affecting the remote terminal 112. The disconnected line may still optionally be used for data communication.

Also part of the remote terminal is a controller 164 which may be in communication with the sensing unit 148 and the actuation unit 152. The controller may oversee, control or guide operation of the sensing unit 148 and actuation unit 152. A data I/O module 156 is configured to connect or interface with the two or more lines 108 to provide a path for data transmitted over the channel to subsequent data communication systems at the remote location. A power out module 160 is also provided and connects to or interfaces with the two or more lines 108 to thereby extract or receive the line powering signals, i.e. power, provided to the remote device 112. In this embodiment, the output from the power out module 160 provides power to all aspects of the remote terminal 112, some of which are not shown, thereby allowing the remote terminal to be line powered. Appropriate isolation may be provided between the data I/O 156, 138 and two or more lines 108, and the power supplies 132, 160 and the one or more channels.

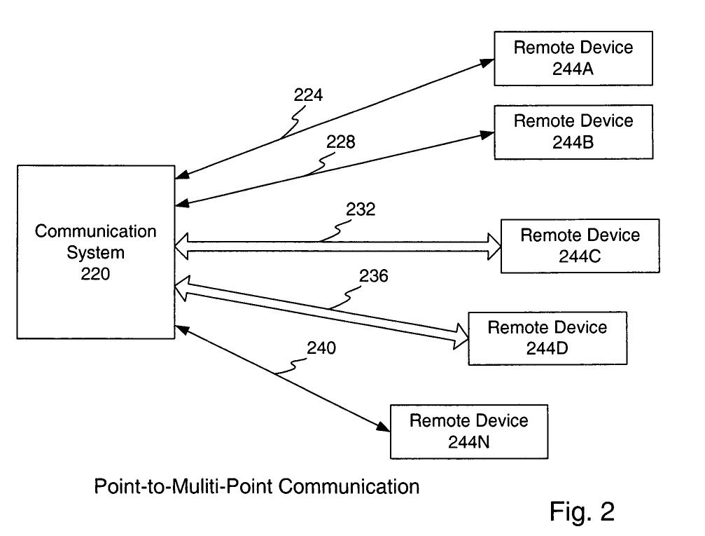

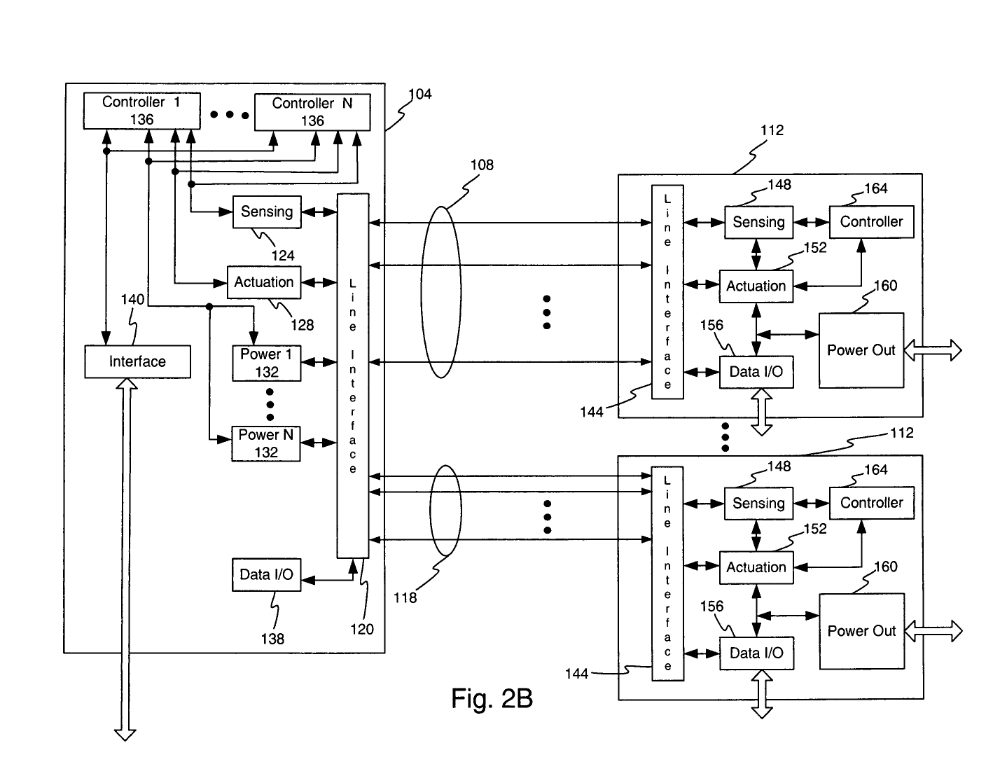

FIG. 2A illustrates an example embodiment of a point to multi-point communication system. A primary communication device 220 is configured at a point location. One or more lines 224-240 extend from the transceiver 220 to one or more remote communication devices (remote terminals) 244A-244N, wherein N may comprise any positive integer. It is contemplated that each of the remote communication device 244 may be located at different locations or that each communication device 244 does not have electrical access to the other remote communication devices 244. In addition, it is contemplated that one or more of the remote devices may be line powered.

This point to multi-point configuration may also be configured with the line powering circuitry as described herein. In such a configuration, the method and apparatus described herein has the benefit of being able to isolate a single line while maintaining operation on the remaining lines which services the multi-point locations. This is an important feature because it would be undesirable for the an unwanted event created by a user at a single point locations 244 to affect or bring down the remote communication devices at the other multi-point locations. The communication system 220 of the method and apparatus described herein is able to detect a fault on a single line and disconnect the line from the line powering system before the fault can affect other remote multi-point locations. Without the teachings of the current invention, this important feature can only be achieved by dedicating separate line powering systems (one for each multi-point location or one for each line) at considerable increase in complexity and cost of the primary communication device.

FIG. 2B illustrates a detailed block diagram of an example embodiment of a line powered, multi-line point to multi-point communication system. The embodiment of FIG. 2B is generally similar to the embodiment of FIG. 1B and as such, identical or similar elements are labeled with identical reference numbers. The following discussion focuses on the aspects of FIG. 2B that differ from that shown in FIG. 1B.

In this embodiment it is contemplated that more than one remote location 112 will receive power from the CO device 104 and that for one or more reasons, the different remote locations may require different power or voltage levels or may be on independent power supplies. Although not required to be configured as shown in FIG. 2B, the CO device 104 of FIG. 2 utilizes multiple power supplies 132, namely, 1 through N where N is any positive whole number. The power supplies 132 may provide the same voltage or power output or different levels. In addition, multiple controllers 136, such as controllers 1 through N, where N is any whole number are provided and may connected as shown. The controllers 136 may be identically configured or configured differently to suit the configuration and operation as described herein. In addition, multiples remote terminals 112 are shown, which may utilize different lines 108 or sets of lines for line powering and data exchange.

In operation, the one or more controllers 136 may selectively control the actuation unit to selectively connect the lines 108 to the power supply 136 which is matched to the desired remote terminal 112. For example, if a particular power level was to be provided to a first remote terminal, then the actuation unit 128, based on instructions from a controller 136, may selectively connect a particular power supply to the lines 108 connected to that remote terminal to thereby supply the proper line power. Likewise, other remote terminals may connect to other matched power supplies. It is further contemplated that not all remote terminals, in a point to multi-point configuration, must be line powered. Hence, in some embodiments only certain remote terminals may be line powered.

During operation, monitoring of all the lines 108 and power supplies 132, even if at different power levels or voltage, may be performed by a single controller 136, or a dedicated controller may be shared between multiple lines or remote terminals 112. In one embodiment a dedicated controller 136 is provided for each remote terminal or for each remote terminal at a different power level. Providing multiple controllers 136 provides the advantage of dedicated, and hence rapid, monitoring and greater control over connection and disconnection of lines.

Another advantage of multiple power supplies is in regard to potential telecommunication standards which limit the total power sourced from any one power supply. For example, certain telecommunication standards may limit the total output from a single power supply to 100 watts. Using the configuration shown in FIG. 2B, multiple power supplies may be utilized thereby enabling more power to be sourced to remote terminal(s). It is contemplated that the power may be provided to different remote terminals 112 as shown in FIG. 2B, or to a single remote terminal as shown in FIG. 1B.

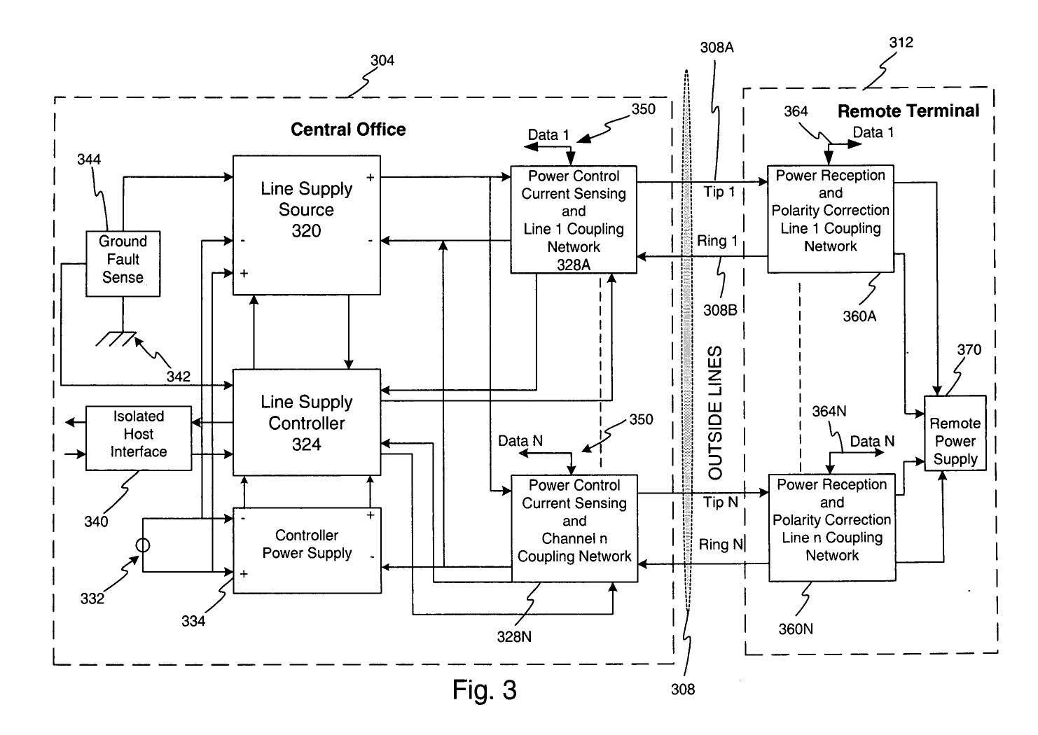

FIG. 3 illustrates a block diagram of an example embodiment of a multi-line communication system with line powering for the remote terminal. This is but one possible example embodiment and as such, it is contemplated that other embodiments may be created that do not depart from the claims that follow. In this embodiment a central office (CO) device 304 communicates with a remote terminal 312 via two or more lines 308. In this example embodiment each line comprises a two conductor pair which may be designated as a tip conductor 308A and ring 308B. Any number of lines may be combined to form the channel. In this example embodiment the remote terminal 312 is line powered via the lines 308 by power supplied from the CO device 304.

Turning now to the CO device 304, a power system for the line powering circuitry comprises a line supply source 320, a line supply controller 324, and Individual Power Control, Current Sensing and Line Coupling Networks (IPC-CS-LCN) 328A. Any number of additional IPC-CS-LCN 328N may also be provided and in this embodiment a PC-CS-LCN 328 is associated with each line. The variable N may comprise any whole number.

The line supply source 320 supplies power to one or more lines out of all of the two or more lines to thereby provide the power for the line power scheme. It is thus contemplated that not all of the two or more lines that form the channel must be used for line powering, although in some embodiments it is contemplated that all lines may be utilized.

The line supply controller 324 guides operation of the sensing and coupling networks 328A and line supply source 320. In one embodiment this may comprise controlling when and under what conditions a line is switched into or out of the line powering circuit, i.e. controls when a line provides power to the remote terminal 312.

The line supply controller 324 and line supply source 320 receive their primary power from a CO Battery 332. Any type battery 332 or power supply may be utilized. In other embodiments the supplied power may be AC and converted to a DC format at any voltage value. The line supply controller may alternatively have its own power supply 334 as shown. In one embodiment the controller power supply 334 provides power to the line supply controller 324.

An isolated host interface 340 may provide data access to the line powering system, such as for example the controller 324. The interface 340 may comprise any type interface capable of providing input and output from the CO line powering circuitry for a user or other system, such as a host. In the example embodiment described herein an isolated two wire host interface 340 provides a communication link to the host to allow control and monitoring of the line source supply. Use of a single interface provides the benefit of simplifying the design and reducing the number of control and status lines that require isolation from the host, as compared to a system that duplicates line powering circuitry for each line and an isolated host for each line.

It should be noted that in most applications voltage isolation is required from the battery 332 to both the line supply source 320 and controller power supply 334. This isolation can be provided in numerous ways with opto-coupler isolation, transformer coupling or capacitive isolation. In this example embodiment the controller power supply 334 is referenced to a negative rail of the line source supply 320 allowing the controller 324 to monitor and control the supply directly. Typically the line source supply 320 as well as the controller 324 can communicate via the isolated host interface 340 with a host processor, electrically isolated from the line supply source.

The line supply source 320 connects to a ground fault sensor 344, which also connects to protective ground 342. The ground fault sensor 344 is configured to limit and sense the ground current, such as, but not limited to, if the outside line 308 connects to this protective ground. The ground fault sensor 344 may also be provided and configured to meet the safety requirements especially when relatively high voltages are applied to the outside lines 308.

Also shown at the CO device 304 in FIG. 3 is a CO data I/O 350, which in this embodiment connects to the power control current sensing and line coupling network (IPC-CS-LCN) 328. The CO data I/O 350 provides data to the IPC-CS-LCN 328 for transmission to the remote terminal 312. Likewise, the data paths 350 carry data out of the IPC-CS-LCN 328 after it has been received from the remote terminal 312 via the lines 308.

Turning now to the remote terminal 312, it can be seen that the remote terminal may receive power via one or more lines 308. In this embodiment the lines 308 connect to an associated coupling network 360A-360N. In this embodiment, each line 308 connects to a coupling network 360. The coupling network 360 functions to provide power transfer from the line to the remote terminal and to establish polarity correction. Polarity correction may be required if the tip wire and the ring wire of the line are mistakenly interchanged when connected to the remote terminal 312 or at the CO device 304. Polarity correction is generally understood and hence not discussed in detail. The power reception function of the coupling network 360 is discussed below in more detail.

The coupling network connects to a remote terminal (RT) data I/O 364. The RT data I/O 364 function generally as described above for the CO data I/O 350 and hence is not described again in detail. The coupling network 360 also connects to a remote power supply 370. The remote power supply 370 receives and combines the power as supplied via each line that is being utilized in line powering circuit and may manipulate the power to a format suitable for use by the communication electronics of the remote terminal.

In operation and in addition to the discussion provided in connection with FIG. 2A, each line that is part of or connected to the line powering circuit receives power at the CO 304 from the line supply source 320. From the line supply source 320, the power is provided to each PS-CS-LCN 328 which in turn provides the power over the line to the remote terminal 312. The number of lines that are used to power the remote terminal 312 is a function of the resistance of the line, which is usually based on line length and gauge, and the power that is required by the remote terminal. In many applications the number of lines that are actively in use providing power is less than the number of lines required or used in the communication link.

As an advantage over prior art systems, the configuration of FIG. 3 operates in such a way as to allow the line powering system to continue to properly function in the event of a power failure or fault on a particular line. In such an event, the line supply controller 324 detects such a failure or fault and signals the coupling network 328 to remove, from the line powering circuit, the line (or pair) on which the failure or fault was detected. In response, the coupling network 328 removes the line from the powering circuit. Consequently the line with the detected fault or failure is no longer powers the remote terminal(s) 312.

In response, the coupling network 360 detects the lack of power on the particular line and, as a result, the coupling network 360 associated with the recently un-powered line disconnects itself from the line. This may occur because the Tip and Ring lines 1 through N at the remote terminal may be commoned at the remote power supply 370 and the fault detected by the Central Office unit 304 would not be cleared by only removing the line from the powering circuit at the Central Office unit. As a result of disconnecting power at the CO line powering unit, both the CO 304 and remote terminal (RT) 312 are disconnected from the particular line thereby maintaining isolation, safety, and operation of the RT and the CO. Other lines 308 may be switched into the line powering circuit to compensate for the loss of power from the disconnected line. Alternatively, the other lines may provide additional power to the remote terminal 312 if not already at capacity.

Certain faults or failures may only affect a line's ability to perform line powering while not affecting the line's ability to perform data transmission. For example, a ground fault on one of wire pairs may be severe enough to make the line powering on that line unsafe of undesirable, but not so severe as to disrupt the data transmission circuit. The method and apparatus as disclosed herein allows for the system to utilize the line for data transmission, while removing it from the line powering circuit. Hence, removal of a line from the line powering circuit does not always require that the line also disconnected from the data circuit. Other faults may warrant removal of the line from service for both line powering and data transmission.

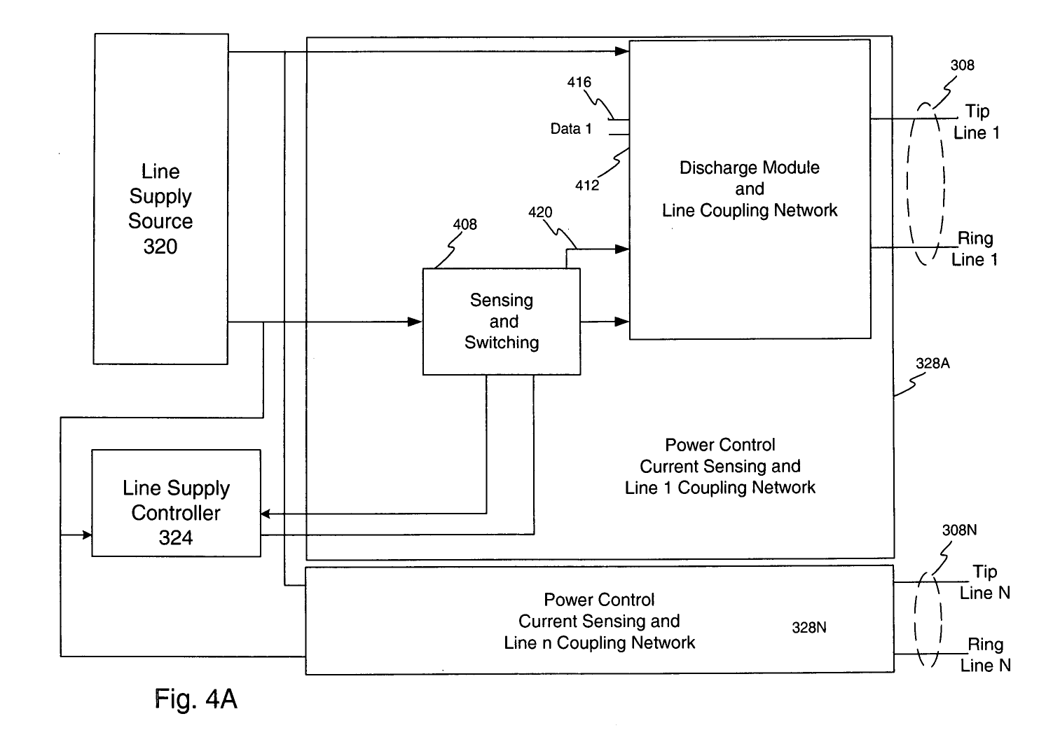

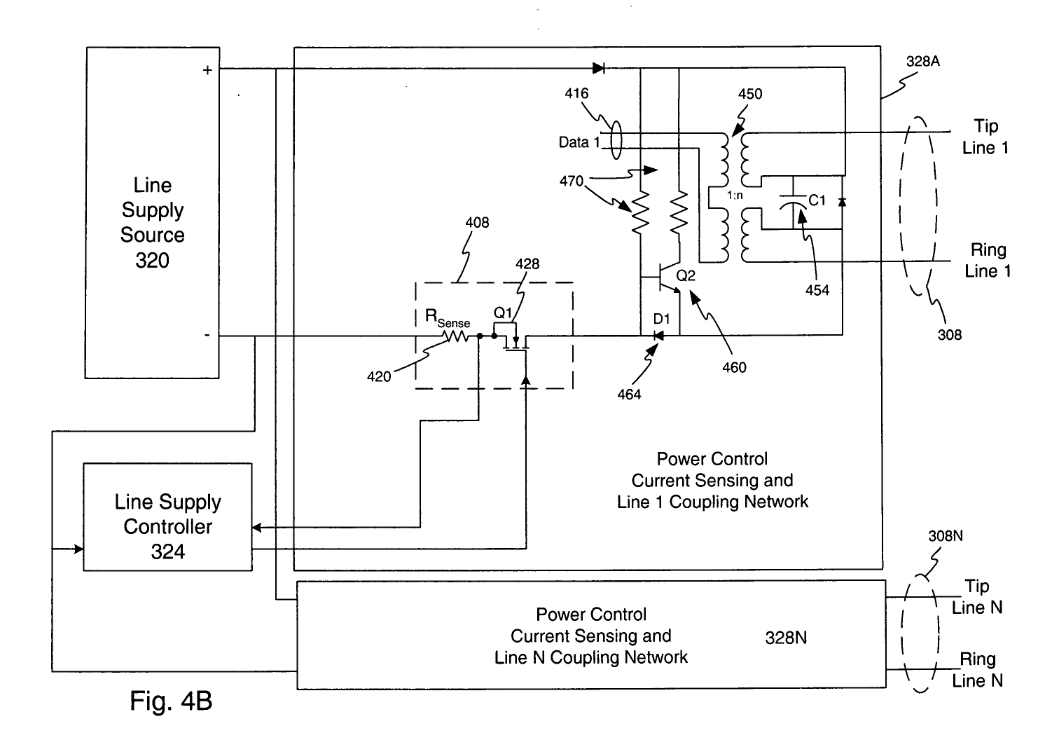

FIG. 4A illustrates a block diagram of an example embodiment of the individual power control, current sensing and line coupling network (coupling network or IPC-CS-LCN) 328A as shown in FIG. 3. This is but one possible example embodiment and as such it is contemplated that other embodiments may be arrived at without departing from the scope of the claims that follow. To aid in discussion and aid in understanding, the line supply source 320 and the line supply controller 324 are shown for reference. Likewise, the lines 308A and 308N are also shown as connected to the coupling network 328A, 328N.

In this embodiment a sensing and switching module 408 connects to the line supply controller 324 and the line supply source 320. In operation and during normal line powering operation, the sensing and switching module 408 provides a path for power from the line supply source 320 to the line 308, which at this stage is part of the line powering circuit. The module 408 and/or the controller 324 may monitor one or more parameters of the line 308A and the power being provided there through. Example of line parameters that may be monitored include, but are not limited to line current, ground fault current tip to ground voltage, ring to ground voltage, line resistance or line to ground leakage resistance.

If a fault or failure is detected by the sensing and switching module 408 or the controller 324, then the controller 324 signals the switching aspect of the sensing and switching module 408 to disconnect the line 308 from the line supply source 320. As a result, the line 308A is disconnected from the line powering circuit and line does not convey power to the remote terminal. It is contemplated that the sensing and switching operation may occur quickly to prevent unwanted current from shorting out the line.

The sensing and switching module 408 may comprise any combination of hardware, software, or both configured to monitor one or more line parameters, as defined herein, and perform switching on the line to connect and disconnect the line to and from the line supply source 320. Examples of elements that may perform sensing include, but are not limited to voltage comparators, analog to digital converters, current to voltage converters, precision references, Examples of elements that may perform switching including but are not limited to mechanical or optical relays, transistors and diodes.

Also shown in FIG. 4A is a discharge and line coupling network module 412. In this example embodiment the discharge and line coupling network module 412 serves to rapidly discharge the line 308 if the line is removed from the line powering circuit. A discharge module is desirable to eliminate the charge left over on the line after it is disconnected, due to the line's capacitance. A data I/O 416 is provided as part of the discharge and line coupling network module for incoming and outgoing data. A control line 420 may be provided to communicate the discharge command to the discharge module from the sensing and switching module 408 or it may occur automatically upon disconnection of the line from the supply source 320. Rapidly discharging the line provides the advantage of allowing the line powering system to meet specifications for fault or failure detection by discharging the line within a specified period of time. Further safety requirements are met by discharging the line before injury can occur.

Any type element may be utilized to discharge the line such as one or more switch assemblies that connect to ground or other discharge path, typically comprising of electronically controlled transistor based or relay based switch assemblies.

FIG. 4B illustrates a diagram of an example implementation of the coupling network 328. As compared to FIG. 4A, identical elements are labeled with identical reference numbers. In this example implementation, the sensing and switching module 408 comprises a sensing resistor Rₛₑₙₛₑ 420 and a semiconductor device 428. The value of resistor is a design choice selected to convert the current passing to the line 308 to a voltage. In this embodiment the semiconductor device comprises a transistor Q₁ 428 configured to switch the negative rail of the line supply, which connects to the line supply source 320. In this configuration the switching occurs directly since the controller 324 is isolated from the -48 volt battery and is referenced to the negative rail of the line supply source. In one embodiment, the transistor Q₁ 428 comprises a MOSFET switch.

The Rₛₑₙₛₑ resistor 420 provides a current to voltage conversion which can be sensed and digitized by the line supply controller 324 via the connection as shown. This provides a digital representation of the current being sourced by line 308. As it is contemplated that a coupling network 328 is associated with each line, the controller 324 is thus capable of monitoring the current drawn or sourced by each line 308. The resistor Rₛₑₙₛₑ 420 may also be selected to provide a specific and desired amount of current limiting by limiting the gate-source voltage of the transistor 428. The resistor Rₛₑₙₛₑ 420 also current limits the gate-source voltage of transistor Q₁ 428.

In this example embodiment the line supply control 324 may comprise any number or type of micro-processor having sufficient digital control ports, a host interface communication port or similar such capability. One or more analog to digital conversion circuit may also be provided, although such actions may occur off-chip. The controller 324 may include or access memory configured to store threshold information, or the controller be hardwired with threshold values. Alternatively, software code may be written with one or more threshold values included therein. The controller 324 may compare the actual current flowing through the line to the remote terminal to the threshold value(s). If the sensed current being source to the line is above, below, or outside the threshold windows, then the controller 324 may remove the line from the line powering circuit. As can be appreciated, numerous different design options are available with regard to the comparison operation.

In this example implementation, the discharge module is configured as shown. The discharge and line coupling network module 412 (FIG. 4A) includes an isolation device 450 with a capacitor 454 configured to transfer data to the line 308A via data I/O 416. The discharge element 460 comprises a transistor Q₂ and a diode 464 configured as shown. One or more resistors 470 are provided to properly bias the transistor Q₂ 460 and provide a discharge path.

In operation, when transistor Q₁ 428 is on, power is applied to the line 308 and the capacitor 454 and any additional line capacitance is charged to the line supply voltage. Operating in conjunction with the sensing and switching element (collectively elements 420, 428) is the transistor Q₂ 460 which quickly discharges the voltage on the line (stored by the combined capacitance). This occurs when the switch is open, i.e. when transistor Q₁ 428 opens. The line power voltage is combined with the data through the line coupling transformer 450 by applying the voltage on each pair through the center tap of the line coupling transformer.

In this example embodiment and assuming a 9000 feet twisted pair line between the primary and the remote communication devices, the capacitance of the line would hold a charge for an undesirably long period of time. This is particularly true, as is discussed below, when monitoring and attempting to remove a faulty or failing line within a limited time period. For example, in the event a fault is detected, all lines must be sensed, and the faulty line removed within a fixed time period. To determine which particular line is failing or faulty, it may be necessary to sense each line individually. Under one specification this process must be complete within 200 milliseconds or less.

Thus, if for example, a high voltage value is sensed by the controller, then a short may have occurred, which would increase voltage across Rₛₑₙₛₑ 420. The controller would digitize the sensed or monitored voltage value and a comparison may occur to a threshold value. Depending on the results of the comparison, the transistor Q₁ 428 would open, i.e. power has been removed from the line. Thereafter, transistor Q₂ 460 will conduct, which rapidly drains or removes the voltage on the line 308. By removing the voltage on the line 308, the ground fault or short circuit will be eliminated. It is contemplated and would be understood by one of ordinary skill in the art that one of the resistors 470 serves as a discharge path while the other biases transistor Q₂ 460. In one embodiment the resistor values are at a ratio of about 100 to 1. In this embodiment the diode 464 reverse biases the base emitter junction of transistor Q₂ 460 and limits the reverse voltage across the base emitter junction of Q₂

As stated above, in an embodiment utilizing a single ground fault detector, it may be important to remove the voltage on the line quickly. In one method of operation where a single ground fault detector is used, the controller may remove one or more lines in a specific sequence from powering the remote terminal while monitoring the ground fault detector to monitor the amount of current leakage to ground from those lines. Once the ground fault detector detects the line which created the undesirable high current leakage, the controller or other apparatus may disconnect the line from the line powering circuit. Hence, it may be important to rapidly discharge the line, once the faulty line is located, to meet specification and prevent an unsafe condition.

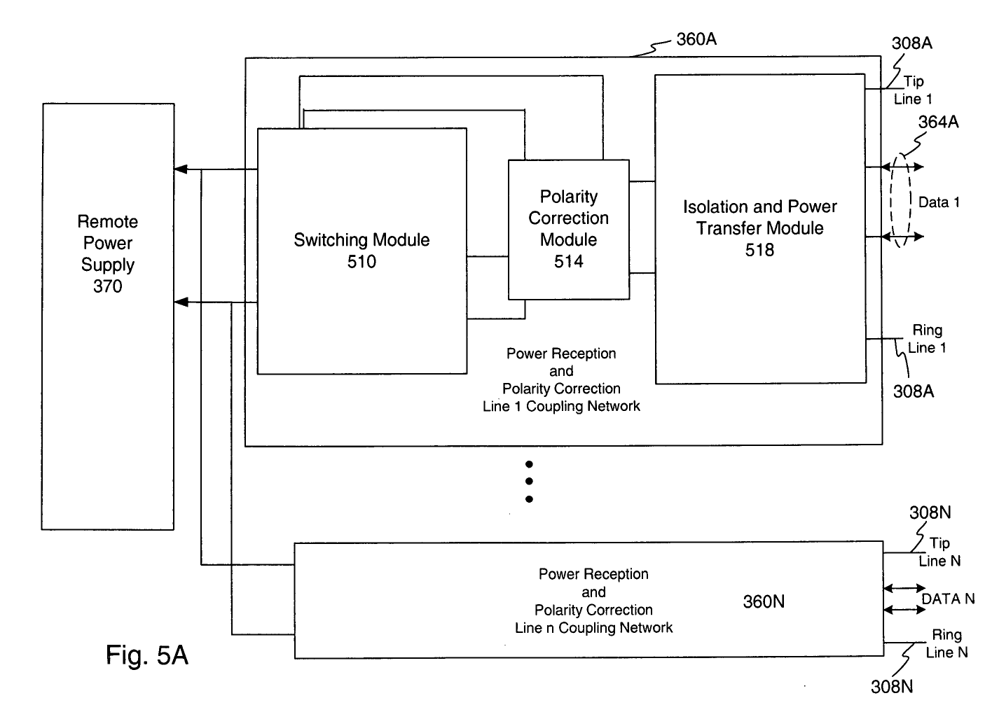

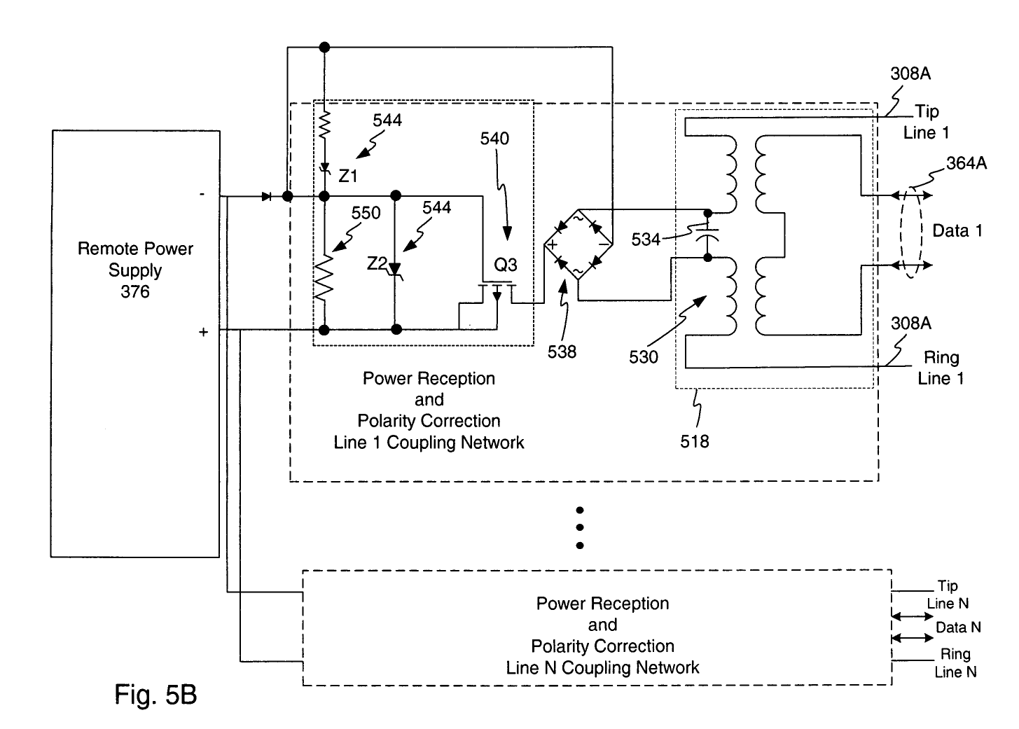

FIG. 5A illustrates a block diagram of an example embodiment of remote terminal coupling network 360 as shown in FIG. 3. This is but one possible example embodiment and as such it is contemplated that other embodiments may be arrived at without departing from the scope of the claims that follow. To aid in discussion and aid in understanding, the remote power supply 370 and other coupling networks 360A-360N are shown for reference. Likewise, the lines 308A and 308N are also shown as connected to the coupling network 360A, 360N. To avoid confusion, the remote power supply 370, which is shown on the right hand side of FIG. 3, is shown on the left hand side of FIG. 5A and 5B. As a result, the channel 308 is shown on the right hand side of FIG. 5A and 5B.

In this example embodiment the line 308A connects to an isolation and power transfer module 518. The isolation and power transfer module 518 is configured to isolate the line 308A from the data output lines 364A. The module 518 is also configured to pull the power from the line 308, and provide this power to a polarity correction module 514. The polarity correction module 514 may comprise any circuit, element, or device capable of correcting for an improper polarity connection of the line 308A.

The output of the polarity correction module 514 connects to a switching module 510. The switching module 510 is configured to detect when power is no longer being supplied from the CO on the particular line, in this case line 308A, and in response, disconnect the line from the remote power supply 370. As an advantage to such an embodiment, the coupling network 360 is configured to disconnect a line 308 based on a detected de-powering of the line by the CO. As a result, a separate communication channel or communication path between the CO and the RT is not required to force the RT to disconnect a line. Action by the detection mechanism at the CO is automatically detected by the switching module 510 or other aspect of the coupling network 360 thereby reducing the cost and complexity of the RT. If the line was not also disconnected at the RT, then because all the lines are combined at the remote power supply 370, the fault detected by the CO would not be cleared and the ground fault sense circuit (344 in FIG. 3) would not be able to sense any additional subsequent faults.

The output of the switching module 510 may optionally connect to the remote power supply 370 to thereby provide power provided by line 308A to the supply. The supply aggregates power from each line 308 to thereby supply the power to the remote terminal. In the event the CO disconnects the line from the line powering circuit, the switching module 510 would likewise detect the disconnection by the CO and disconnect the power on the incoming line from the remote power supply 370. This prevents a faulty or failing line from disrupting operation of the ground fault sense circuit at the CO.

In this example embodiment, a coupling network 360A is associated with each line 308 that may be used for line powering, while a single remote power supply may be shared to combine the power from each line. As shown, additional coupling networks 360 may also be provided, the output of which feed into the remote power supply 370.

FIG. 5B illustrates an example implementation of the example embodiment of FIG. 5A. This is but one possible example implementation. In this implementation, the isolation and power transfer module 518 comprises one or more transformers 530 to perform isolation. As can be seen, the line 308A connects from the center tap of the transformer 530 to the polarity correction module 538, while the data is mirrored via the transformer to data I/O 364. A capacitor 534 is provided as shown to block any DC connection from tip to ring.

In FIG. 5B, the polarity correction module comprises a full-wave rectifier bridge to correct the polarity. In the case of a two conductor twisted pair conductor, if the tip and ring are crossed when connected at the remote terminal, the polarity will be reversed. The full-wave rectifier bridge will correct such an event thereby aligning the voltage polarities into the Remote Power Supply 376 in the event of Tip/Ring inversions between the individual lines.

In this implementation the switching module comprises a voltage controlled switch, which comprises a PMOS transistor Q₃ 540 and zener diodes Z₁, Z₂ 544 as shown. A resistor 550 is provided to bias the gate of the PMOS transistor 540.

The voltage controlled switch is designed to have a specific turn on voltage by appropriate selection of zener diodes 544. The turn on voltage is related to the line voltage such that a minimum voltage on the line 308 must be present for the switch to conduct, i.e. connect the line to the remote power supply 370. This allows the line 308 to be automatically removed from powering the RT by controlling whether voltage is applied to the line at the CO. As discussed above, this provides a significant advantage over prior art systems that did not provide automatic removal of the failing or faulty line at the RT based on line powering at the CO.

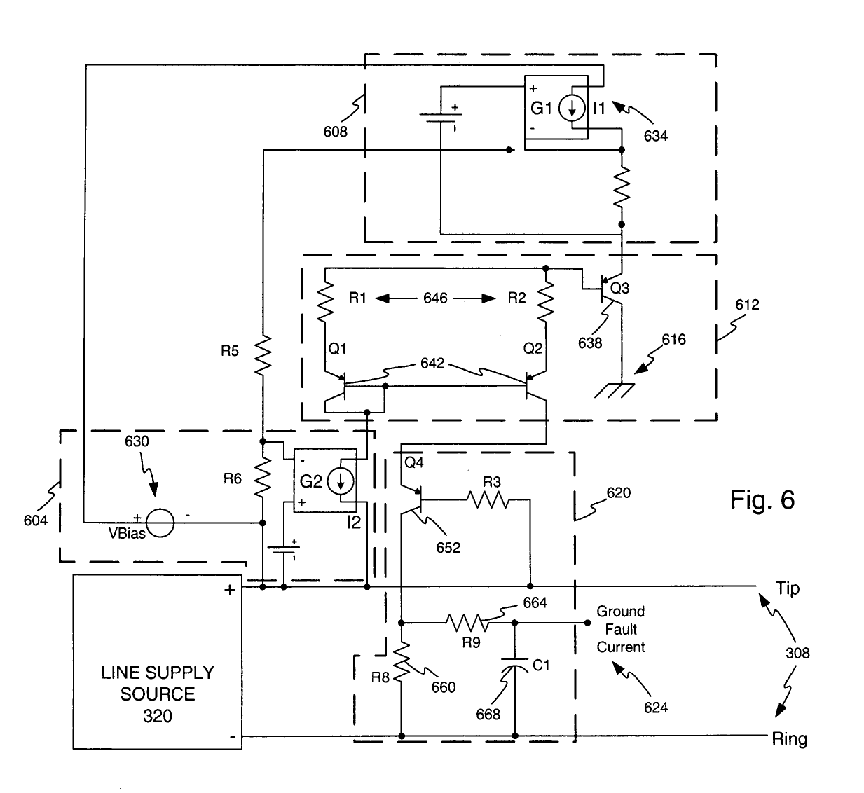

FIG. 6 illustrates an example embodiment of a ground fault sensor, such as for example element 344 in FIG. 3. The embodiment of FIG. 6 may be simplified by grouping the components as follows. A line supply source 320 connects to the tip and ring lines 308. A bias voltage generator 604 provides a bias voltage to a current source 608. The current source outputs a reference current to a divider network 612, which includes a protective ground 616. The divider network 612 connects to the bias voltage current divider 604 and a voltage converter and filter 620. The voltage converter and filter 620 converts the current received from the current divider 612 to a voltage of desired scale referenced to the negative rail of the Line Source Supply 320, which may be detected by a controller or processor which connects to output 624. In this generalization, the current provided to the voltage converter and filter 620 is related to the leakage current to protection ground in the line 308 and hence, leakage current in the line, such as in the event of a fault, may be detected at the output 624.

As way of background, safety regulations require limiting currents that flow to ground, when voltage levels on the line exceed a certain threshold when measured with respect to ground. Thus, the amount of current that may flow to ground and the duration such current may flow is limited. The example implementation shown in detail in FIG. 6 limits the current which may flow to protection ground and processes the current to a format suitable for monitoring. In one example the monitoring is done by a controller or processor.

Returning now to FIG. 6, as discussed herein the Line Supply Source 320 is referenced to protective (or chassis) ground 616 (element 344 on FIG. 3) through the ground fault sense circuit. In general, this ground fault sensing circuit is designed to limit the ground fault current in the event of a fault as well as mirroring the ground fault current with respect to the negative rail of the line supply source 320 so that it can be measured by the line supply controller which is referenced to the same rail.

In this example the line supply source 320 provides a positive voltage V_{Bias} from source 630 which in turn powers a precision current source 634 which generates a reference current I₁. As a result, the TIP conductor is biased negatively with respect to the reference ground 616. When there is no resistance between the reference ground and either the TIP or RING this reference current I₁ flows through the base of a transistor Q₃ 638. This current is split between transistors Q₁ and Q₂ 642 as determined by the ratio of resistor R₁ and R₂ 646 with most of the current flowing through R₁ a smaller resistor as compared to R₂. Resistor R₁ is selected to minimize the power dissipation in the transistor Q₄ 652. The collector of transistor Q₄ 652 is referenced to the negative rail of the line supply source 320.

In operation, the voltage bias generator 604 generates a bias voltage for current source 634. The current source 634 generates the reference current which flows into transistor Q₃ 638 and either to the ground 616 or to the divider of R₁, R₂ and Q₁, Q₂.

In the event of a no ground fault condition, the reference current I₁ flows into divider network R₁, R₂ and Q₁, Q₂ . The current flowing through transistors Q₂ and Q₄ 642 and 652 is converted to a voltage by a resistor R₈ 660 and is filtered by a resistor R₉ 664 and a capacitor C₁ 668. The voltage generated by resistor R8, is provided on output 624, it is now referenced to the negative rail of the line supply and the line supply controller (not shown) can digitize this voltage directly.

The reference current I₁ through transistor 638 Q₃ under the no fault condition is selected to be slightly less than the maximum current which is allowed to flow to ground 616 in the event that the line 308, either the TIP or RING, is ground faulted. In one example embodiment, the reference current I₁ is approximately 4.8 ma when the maximum allowable fault current is 5 ma. In other configurations other values may be utilized. The resistor R₈ 660 is selected to provide the full-scale input range for the line supply controller A/D under a no fault case.

When ground currents flow through the reference ground 616, the ground current is subtracted from the constant reference current I₁ current which flows through the emitter of transistor Q₃ 638. As a result, less current will flow through the base of transistor Q₃ 638 and transistors Q₂ and Q₄ 642 and 652. This will force the voltage output 624 to decreases as the ground fault current increases which, in turn establishes a linear indication of the ground fault current. In this way, potential faults can be identified and the line switched out of the line powering circuit before the affected line causes other aspects of the communication system to fail. As discussed above, the line supply controller which receives or reads the voltage on output 624 can be any type of device or number of devices having sufficient I/O, host communication interface and an A/D converter of sufficient speed and precision to perform the algorithms illustrated below.

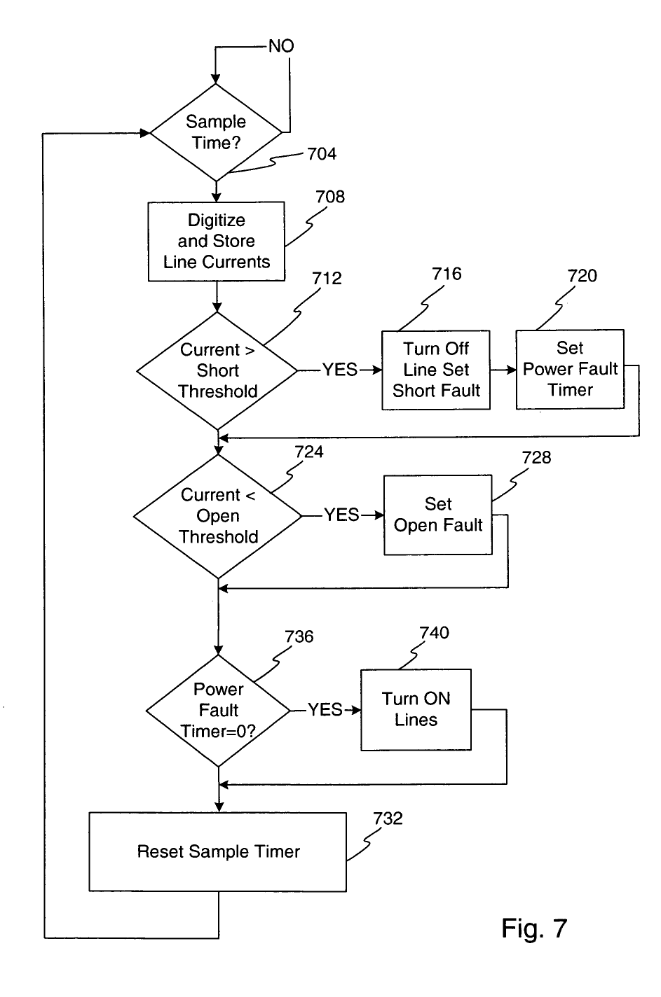

FIG. 7 illustrates an operational flow diagram of an example method of operation, such as for example, a typical method of operation for monitoring the line currents. One focus of this method of operation is to provide an indication of the currents through each line in normal operation. The method may also provide real time monitoring as determined by the loop sampling time of line opens and shorts by comparing the measured currents to programmable thresholds that are set by the host processor, that may communicate with the controller in 324 (FIG. 3) via the interface 340 (FIG. 3). These thresholds, which may be user configurable, vary by application and the number of lines used to power the remote device.

In the event of a short circuit, a power fault timer is set which prevents the line from being re-enabled until the fault timer is decremented to zero. The timer may be configured in hardware, software, or a combination of both. The time period that a line is disconnected may also be programmable by the host controller. After this time period, the system may be configured to automatically re-connect or attempt to re-enable the line if the fault condition has been removed.

Turning back to FIG. 7, at a step 704 the operation determines if it is time to take a sample of the current on a line. It is contemplated that the sampling may occur continuously in real time, or periodically. If it is not time for a sample, then the operation returns to step 704, such as in a timer loop.

If at step 704 it is determined that a sample should occur, then the operation advances to step 708 wherein the system digitizes and stores the values that represent one or more line currents. Thereafter at decision step 712, the operation determines if the current is greater than a threshold, which would indicate a short on the line. If a short is detected, then the operation advances to step 716 wherein the system turns off the line, such as by removing the line experiencing the short from the line powering circuit. A flag or other indicator may be set at this time establishing or setting a short fault. At a step 720 the operation sets a power fault timer. The power fault timer may be configured to initiate a reconnect of the line after a predetermined period of time, which is controlled by the timer. Thereafter, the operation advances to a step 724 as shown.

At step 724 the operation compares the sensed current value to an open threshold, namely, a low current threshold value, which, if the sensed current is below that value, is indicative of an open circuit. If an open circuit is detected, then the operation advances to step 728 wherein an open circuit flag is set. This establishes or sets an open circuit fault.

After both of steps 724 and 728 the operation advances to step 736. At step 736, the operation determines if the power fault timer has reached zero. The power fault timer controls when a disconnected line, i.e. a line in fault mode, may be reconnected to the system and subject to subsequent line monitoring.

If at step 736 the operation determines that the fault timer has reached zero, i.e. counted down to an expired state, then the system turns on the faulted lines at step 740, such as by reconnecting them to the line power circuitry. It is contemplated that after a period of time (e.g., in a subsequent iteration), the line may be re-tested or monitored to determine if the fault or failure is still present. Certain faults or failures may only last a short period of time and as such, after the fault or failure has passed, the line may be reconnected to provide sufficient power to the remote terminal and sufficient redundancy in the event one or more other lines experience a fault or failure. Finally, the operation advances to step 732 wherein the sample timer is reset, before returning to the beginning of the loop 704.

In different embodiments the line reconnection operation may occur one or more times or may be programmable by a technician. Additionally, other parameters may be monitored such as power supply voltage, output power, etc. The monitoring may occur to in order to comply with certain regulatory requirements, which limit how much power may be sourced to the lines from a single power supply or to insure compliance with any other requirement or for any other reason.

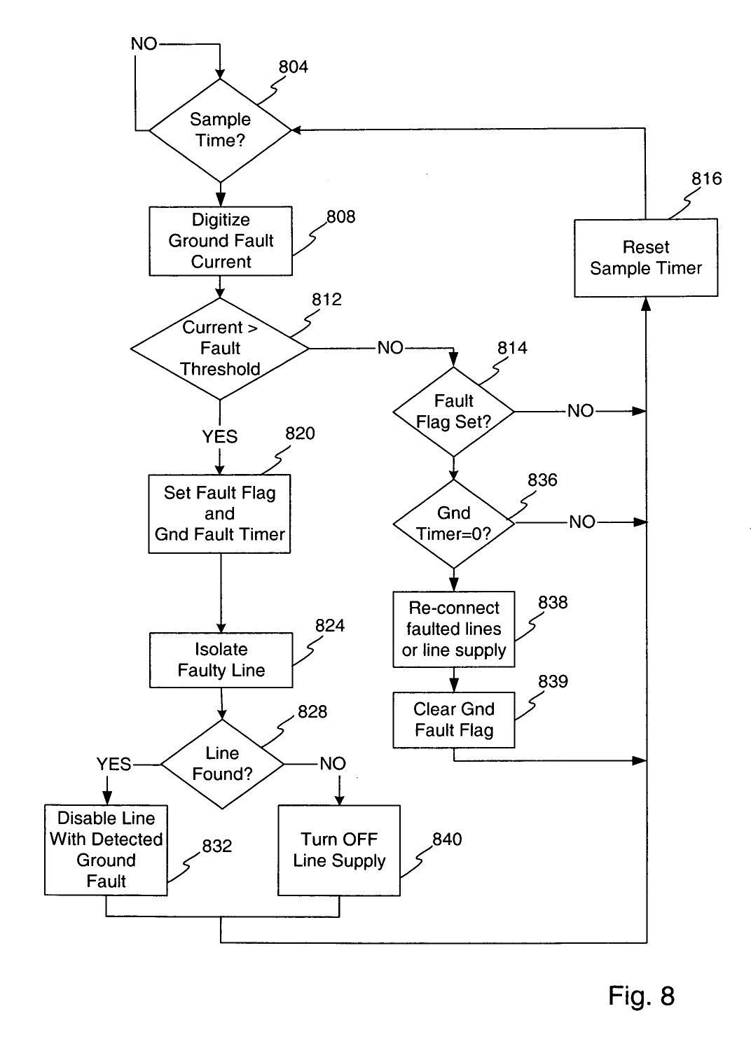

FIG. 8 illustrates an operational flow diagram of a typical exemplary method for monitoring ground fault conditions. The ground fault detector measures the combined ground fault from all lines which are enabled for powering; when a fault condition occurs the method isolates the line creating the fault in a period of time as specified by the applicable regulatory requirements. The removal of the fault works in conjunction with the voltage controlled switch at the remote terminal. Due to the fact that all lines may be DC connected through diode bridges at the remote terminal, the fault is removed by disconnecting the faulty pair both at the CO and the remote terminal. In this example embodiment, the fault is detected at the CO and removed from service by turning off power at the CO from the faulty line. This may be referred to herein as removing the line from the line powering circuit. This in turn causes the remote terminal voltage controlled switch to DC disconnect this line.

In general in this example embodiment, at a sampling event the ground fault current is digitized and compared to a threshold to determine if a ground fault condition exists. This comparison can be made directly on the sampled value or a filtered version of the current to provide some amount of noise rejection in the event of a ground fault transient. If a fault condition occurs the fault is isolated by disabling the power from one or more lines and re-examining the ground fault current. If the faulty line has been identified, the ground fault current will be removed when the selected line has been disabled. This scheme takes advantage of the fact that in typical applications not all the lines are required to power the remote terminal. Thus the fault can be identified without having to remove power from the remote terminal, which is a significant benefit over the prior art. If the fault cannot be isolated, then the power on all lines may be removed. If a fault occurs, a ground fault timer may be set and decremented to zero before the faulted lines are re-enabled to determine if the fault has been removed.

Turning now to FIG. 8, at a step 804 the operation determines if it is time to sample the ground fault current. If not, the loop timing remains in operation until the timer has expired. If it is time to sample the ground fault current, then the operation advances to step 808 wherein the ground fault current is digitized. As discussed herein, the current may be converted to a voltage, which may be monitored, digitized, and related to a current value. Once digitized, the operation may advance to step 812 where the ground fault current is compared to a fault threshold. The fault threshold may comprise a maximum allowable value or a range of values which the ground fault current may fall below or within.

If at step 812 the operation determines that the ground fault current is greater than the fault threshold, then the operation advances to a step 820. At step 820 the system sets the ground fault timer and also sets a fault flag. The ground fault timer is a timer which times how long a line has or will be disconnected from the line powering circuit due to the detection of a ground fault. It is contemplated the line with a detected ground fault may be reconnected and re-sampled after the ground fault timer time period.

At a step 824 the operation isolates the faulty line. This may occur in any manner, including but not limited to activating a switch to disconnect the line with the ground fault from the line powering circuit. In this example embodiment, the step of isolating the faulty line may comprise removing each line that is part of the line powering circuit to determine which of the potentially multiple lines connected to the line powering circuit is experiencing the ground fault. Upon detection of the line experiencing the ground fault, that particular line would be disconnected from the line powering circuit. To achieve this manner of operation, at a step 828 the operation queries to determine if the line, i.e. which line, with the line fault has been detected. If it has, then the operation advances to step 832 where the operation disables the line on which the ground fault was detected. This removes the line from the line powering circuit. As discussed above, the remote terminal would also detect that this line had power removed at the CO, and disconnect that line from the RT as well.

If at step 828 the line with the ground fault has not been detected and all the lines have been analyzed, then the operation advances to a step 840 At step 840 the operation turns off the line supply. In one embodiment this comprises disconnecting all lines from powering, or turning off the line supply source. After step 832 or step 840, the operation advances to step 816, which is discussed later.

Returning now to the comparison step 812, if at step 812 the operation determines that the current is less than the fault threshold, then the operation advances to step 814 where the fault flag is checked. The fault flag indicates that a fault has been detected in the past resulting in one or more disconnected lines, and that the fault has not been cleared yet. In that case, the method advances to step 836 in order to examine the ground fault timer and attempt to reconnect the faulted lines as explained next.

At step 836 the operation determines if the ground fault timer has reached zero, i.e. has counted down. If it has not counted down or reached zero, no special action is necessary. The method completes the sample loop tasks by advancing to step 816. If the timer has counted down to zero or other predetermined value, the operation advances to steps 838 and 839. At step 838 the operation may optionally re-enable one or more of the faulted lines and at step 839 the operation clears the fault flag. In one embodiment this may comprise reconnecting the line to the line powering circuit and removing or resetting any fault indicators or flags for this line. Although most often only one line will fault at a time, it is contemplated that multiple lines may enter 5 a fault situation at the same time. If this does occur, the system may maintain a timer for each line, or act on all the faulted lines in the same manner at the same time. From step 839 the operation returns to step 816 wherein the system resets the sample timer and returns to step 804 as shown.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for line powering a multi-line remote communication terminal from a primary communication device comprising:
receiving power at a primary communication device;
selectively setting one or more switches to energize one or more lines with power to thereby power the remote communication terminal;
receiving power at the remote communication terminal via the one or more energized lines;
monitoring the one or more energized lines for a fault or failure;
responsive to detecting a fault or failure, disconnecting the energized line on which the fault or failure was detected.

2. The method of claim 1, wherein a fault or failure comprises a high current event, a low current event, a high voltage event, a low voltage event, or a ground fault event.

3. The method of claim 1, further comprising:
responsive to detecting a fault or failure, establishing a timer;
monitoring the timer and responsive to the timer, re-connect the disconnected line to thereby re-energize the line.

4. The method of claim 3, further comprising monitoring the one or more energized lines for a fault or failure after re-connection; and
responsive to detecting a fault or failure, disconnecting the re-connected line on which the fault or failure was detected to thereby de-energize the re-connected line.

5. The method of claim 1, wherein the monitoring is performed by a processor.

6. The method of claim 1, further comprising detecting at the remote communication terminal the disconnecting of the energized line at the primary communication device and, responsive to the detecting at the remote communication terminal, disconnecting a power supply at the remote communication terminal from the de-energized line.

7. A method, for use with a multi-line communication system, for locating a communication channel on which a ground fault is occurring and disconnecting the line from a line powering circuit, the method comprising:
providing power to line powering circuit within in a multi-line communication system;
connecting the powered lines to a line powering circuit to thereby create powered lines to thereby provide power to a remote terminal;
monitoring ground current sourced to ground from all of the powered lines;
comparing ground current to a threshold;
responsive to a ground current that is greater than the threshold, disconnecting one or more powered line from the line powering circuit and re-comparing the ground current to the threshold until the ground current is less than the threshold; and
upon re-comparing, if the ground current is less than the threshold, stopping the disconnecting and leaving the presently disconnected line disconnected, either permanently or temporarily.

8. The method of claim 7, wherein the multi-line communication system may comprise a point to point communication system or point to multi-point communication system.

9. The method of claim 7, wherein the method utilizes a single shared ground current detector.

10. The method of claim 7, wherein disconnecting comprises utilizing a switch within an integrated circuit element to disconnect a line from the line powering circuit.

11. The method of claim 7, further comprising detecting, at a remote terminal, the disconnecting of a line, and responsive to the detecting, disconnecting the disconnected line at the remote terminal from a remote terminal power supply.

12. A system for line powering a multi-line remote communication terminal via one or more communication lines comprising:
one or more power supplies configured to provide power to one or more communication lines;
one or more actuation units configured to selectively connect power to one or more of the communication lines to create one or more powered lines;
one or more sensing units configured to monitor one or more aspect of one or more powered lines to create line status information;
one or more controllers configured to:
receive line status information from the sensing unit;
process the line status information to determine if a fault or failure is present on a line;
responsive to a fault or failure, controlling one or more actuation units to disconnect power from one or more lines on which a fault or failure was detected.

13. The system of claim 12, further comprising one or more discharge modules connected to one or more of the powered lines, at least one of the discharge modules configured to discharge power on at least one line responsive to at least one line being disconnected from power.

14. The system of claim 12, further comprising a remote communication terminal configured to receive power via one or more communication lines and supply the received power from a remote communication terminal power supply to the remote communication terminal, the terminal comprising one or more coupling networks configured to detect removal of power from a line and responsive to such detection, disconnect the line from the power supply in the remote communication terminal.

15. The system of claim 12, wherein at least one of the one or more controllers comprises a processor and machine readable code, the machine readable code executing on the processor.

16. The system of claim 12, wherein the line status information comprises a voltage value and the controller converts this voltage value to a digital value, performs a comparison of the digital value to threshold, and responsive to the comparison, removes power from the line associated with the line status information.

17. The system of claim 12, further comprising a timer configured to generate a signal, after a predetermined amount of time, which reconnects the disconnected line to power.

18. The system of claim 12, further comprising one or more ground fault detectors configured to detect a ground fault and, responsive to the detection, provide a signal to one or more controller.

19. A line powering system for a multi-line communication device having a central office terminal and one or more remote terminals, wherein the one or more remote terminals receive data and power from the central office terminal, the system comprising: p1 at least one power source at the central office terminal configured to supply power to one or more lines which may be selectively connected to the at least one power source;
a controller configured to monitor the one or more lines connected to the at least one power source and generate one or more switch control signals;
one or more switches configured to selectively connect or disconnect, responsive to the one or more switch control signals, one or more lines to the at lest one power source to thereby provide power to the one or more remote terminals.

20. The system of claim 19, further-comprising an interface configured to provided access to the controller from a host.

21. The system of claim 19, wherein a single controller and power source is shared by all of the lines and a switch is associated with each line.

22. The system of claim 19, further comprising a discharge module connect to at least one line to discharge line power by shunting line power.

23. The system of claim 19, further comprising a ground fault detector configured to detect a ground fault on at least one line and provide a ground fault detected signal to one or more switches, at least one controller, or both.

24. The system of claim 19, further comprising at least one remote terminal configured with remote terminal line powering components comprising:
a power supply configured to receive and combine power from two or more lines and provide power to the remote terminal;
a sensing and switching module configured to detect when power is not present on a line and, responsive to a line not being powered, disconnecting the line from the power supply.

25. The system of claim 24, wherein the sensing and switching module is further configured to connect a line to the power supply when the line is connected to at least one power source at the central office terminal.

26. A line powering system for a multi-line point to multi-point communication device having a central office terminal and at least two remote terminals located at the same or different remote locations, wherein the at least two remote terminals receive data and power from the central office terminal, the system comprising:
one or more power sources at the central office terminal configured to supply power at the same or different voltage levels, wherein at least one power supply is configured to selectively connect to one or more lines;
at least one controller configured to monitor the one or more lines connected to the one or more power sources and generate one or more switch control signals responsive to at least the monitoring;
one or more switches configured to selectively connect or disconnect, responsive to the one or more switch control signals, one or more lines to at least one of the one or more power sources to thereby provide the same or different voltage levels to at least two of the remote terminals.

27. The system of claim 26, wherein at least one controller is associated with each power source.

28. The system of claim 26, wherein a single controller is shared by all of the power sources.

29. The system of claim 26, further comprising a discharge module connected to at least one line to discharge line power by shunting line power.

30. The system of claim 26, further comprising a ground fault detector configured to detect a ground fault on at least one line and provide a ground fault detected signal to one or more switches, at least one controller, or both.

31. The system of claim 26, further comprising at least two remote terminals connect to the line powering system via two or more lines, wherein at least one of the line powering components comprise:
a power supply configured to receive and combine power from one or more lines and provide power to the remote terminal;
a sensing and switching module configured to detect when power is not present on one or more lines and, responsive to one or more lines not being powered, disconnecting at least one line from the power supply.

32. The system of claim 31, wherein the sensing and switching module is further configured to reconnect one or more lines to the power supply when the one or more lines are reconnected to the power at the central office terminal.
